(19) United States
(12) Patent Application Publication
(10) Pub. No.: US 2022/0388587 A1
(43) Pub. Date: Dec. 8, 2022

(54) Bicycle Saddle and Bicycle Saddle Assembly

(71) Applicant: VANMOOF B.V., Amsterdam (NL)

(72) Inventor: Ties Jonan Midas Carlier, Amsterdam (NL)

(21) Appl. No.: 17/775,066

(22) PCT Filed: Nov. 9, 2020
(86) PCT No.: PCT/NL2020/050704

§ 371 Date: May 6, 2022

(30) Foreign Application Priority Data
Nov. 7, 2019 (NL) 2024185

(51) Int. Cl. B62J 1/08; B62J 1/26; B62J 1/22; B62J 1/24; B32B 5/18; B32B 27/06

(52) U.S. Cl. CPC B62J 1/08; B62J 1/26; B62J 1/22; B62J 1/24; B32B 5/18; B32B 27/065; B32B 27/34

(57) ABSTRACT

The present invention relates to a seat for providing of a seat for a person on a bicycle, including an optional support assembly for mounting of the title to the bicycle, such as including a support member for supporting by the support assembly of a seat assembly. The support member is preferably mountable or fastened to a saddle pin. The seat assembly includes a support element, fixation means for fixation of the seat assembly to the support member, buffer means, supported by the support element, for providing of a buffering all forces between the bicycle and the person, and a seat surface defined by the upper side of the buffer means. The support element provides a substantially rigid support supporting the buffer means relative to the support member, the support element in top view substantially defines the shape of this support, and the support element is arrangeable on the support member.

### CROSS-REFERENCE TO RELATED APPLICATIONS

This application is the United States national phase of International Application No. PCT/NL2020/050704 filed Nov. 9, 2020, and claims priority to The Netherlands Patent Application No. 2024185 filed Nov. 7, 2019, the disclosures of which are hereby incorporated by reference in their entirety.

### BACKGROUND OF THE INVENTION

### Field of the Invention

The present invention relates to a bicycle seat for providing of a seat for a person on a bicycle.

### Description of Related Art

A bicycle has a known bicycle seat that is mountable to a saddle pin that is fixed relative to the seat tube by camping it at the top side thereof at a number of height positions. This way of mounting to a bicycle is de facto standard and advantageous because this allows for an optimization of the height of the seat in relation to the length of a leg of a user. Furthermore, at the bottom side of the bicycle seat, the seat clamp is commonplace with which the seat can be adjusted horizontally depending on the angle of the seat tube of a bicycle relative to gravity. As a result, it has been realized in practice in an economical way that a seat is also usable compared to any seat tube. For this purpose, the actuals bicycle seat as a construction at the bottom of it for mounting it to the seat type.

Such constructions have as a disadvantage that of the bicycle seat, such parts are uncomfortable when grasping the saddle as a number of parts at the underside of the seat attached when picking up the bicycle at the seat. Furthermore, such a construction provides an appearance that detracts from the design of the bicycle as disappearance is determined by the visible parts. A further disadvantage is that when manufacturing the bicycle, the seat is to be connected to the seat clamp which limits the design freedom for the design of the seat.

### SUMMARY OF THE INVENTION

In order to overcome such disadvantages, the present invention provides a bicycle seat for providing of a seat for a person on a bicycle, comprising:
an optional support assembly for mounting of the title to the bicycle, such as comprising a support member for supporting by the support assembly of a seat assembly wherein the support member is preferably mountable or fastened to a saddle pin,
the seat assembly comprising:
   a support element,
   fixation means for fixation of the seat assembly to the support member,
   buffer means, supported by the support element, for providing of a buffering all forces between the bicycle and the person,
   a seat surface defined by the upper side of the buffer means, wherein:
the support element provides a substantially rigid support supporting the buffer means relative to the support member,
the support element in top view substantially defines the shape of this support, and
the support element is arrangeable on the support member.

An advantage of such a bicycle seat according to the present invention is that the design freedom is obtained that may freely aim at the bicycle seat redesigned wherein no account has to be taken, for example, collectability to the saddle clamp. Furthermore, the side and the underside may be designed in freedom for comfortable grasping by the hand of a rider. With this, parts may be avoided that cause discomfort with such grasping. Furthermore, design freedom is obtained for designing of a bicycle seat in a way that fits the design of the bicycle as a whole because design requirements according to the prior art may be avoided.

A further advantage of a bicycle saddle according to the present invention is that a limited built height between the top side of the top tube and the top side of the saddle is achievable because of which the distance between the battles and/or the surface of the earth and top side of the saddle is relatively limited because of which a person with relatively short legs can use a bicycle with a relatively large frame. Depending on parameters as seating comfort or suspension comfort, height savings are achievable of several centimeters to about a decimeter.

According to a first preferred embodiment, the support element is embodied as a support body, preferably embodied as a formed body, further preferably formed by means of a molding operation or a forming operation from a plate material. By means of such a support body, a flat basis is achievable for supporting thereon of the buffer means, which for example contributes to the limited built height of the seat also pairing this with a suitable support.

According to a further preferred embodiment, the buffer means are arrangeable on or are arranged on the support element. With this, also a contribution to the limited built height is achieved.

According to a further preferred embodiment the buffer means comprise at least one zone of material in which each at least one zone of material comprises predetermined buffer characteristics in itself, buffer means are realized wherein each zone of material provides relatively advantages for characteristics at the location of this zone of material. With this, a relatively firm buffer may be arranged at the location of the underside of the seat bone and a for example relatively soft buffer arrangeable in the middle of the saddle.

For the purpose of providing a further seat comfort, the buffer means comprise at least one height zone wherein each at least one height zone comprises predetermined buffer characteristics in itself. By means of such a height zone, a relatively longer suspension travel with a suitable suspension force is definable at desired locations, such as at the location of the seat bone. Between such height zones it is further provided that other zones may be filled with very soft foam for realizing an even surface while maintaining comfort provided by relatively solid height zones and/or specific zones of material.

To this end, according to a further preferred embodiment, the buffer means provide a suspension travel depending on a force exerted thereon by a person.

Further preferably, the buffer means comprise at least a resilient support element, preferably two resilient support elements on both sides relative to the middle as seen in the direction of travel, such as at the location of the respective seat bone. With this, the support, suspension travel and/or comfort at the location is maximized. Further preferably, the resilient support element comprises a gas-filled suspension element. Further preferably, the resilient support member comprises a gel filled suspension element. Further preferably, the resilient support member comprises spring means, such as a sheet spring or a compression spring, such as a conical compression spring. Such a conical compression spring for example has a comfort rating advantage that a relatively large support surface is achievable.

According to a further preferred embodiment, the at least one zone of material comprises at least one zone of material with a hard foam and/or at least one zone of material with a soft foam. The effect of a relatively soft foam may be realized by a relatively hard foam with removed recesses.

For the purpose of comfort at the location of the middle of the seat, 1 of the at least one zone of material comprises a soft zone of material or a hard zone of material between the left side and the right side of the seat. With this, at that location, a relatively soft comfort zone is achievable for the purpose of a middle part of the human body.

According to a further preferred embodiment, the bicycle seat comprises a mechanical support at the front and/or at the rear of the saddle. With this, a resilient effect of the support element is achievable. Furthermore, a centering effect with respect to the rider is achievable. Further preferably, the bicycle seat comprises a resilient support, such as comprising a rubber, at the front side and/or at the rear side of the seat. With this, a suspensive effect is realized and/or a relatively high dampening is achieved.

According to a further preferred embodiment, the underside of the buffer means are formed by a holder layer holding dampening material or the resilient support element. Such a holder layer is preferably manufactured from a nylon with therein shaped recesses or hollow spaces or spaces for arranging therein of a suspense of material, such as a foam or a rubber, such as TPR.

Further preferably, the buffer means comprise a comfort layer, such as comprising memory foam, soft PP and/or hard PP. with this, the comfort for the rider is improved relative to the support that is provided by the support element.

Further preferably, the seat surface is formed by the top side of the buffer means and/or by a cover layer or wear layer. With this, the shape of the bicycle seat and the characteristics relative to the rider, as well as the durability of the bicycle seat is improved.

According to a further preferred embodiment, the support element defines a height variation for providing of at least 2 height zones, each with a respective vertical push in travel or suspension travel. With this, it is for example achievable that a suspension travel at the location of the seat bone is relatively longer than a suspension travel near the middle or the front side of the bicycle seat. A longer suspension travel improves for example the conference with respect to writing over an unevenness.

According to a further preferred embodiment, the bicycle seat comprises adjustment means for adjusting of the position of the seat assembly relative to the support member in a horizontal direction, such as in the direction of travel of the bicycle. With this, the positioning of the rider relative to for example the crank and/or the handlebar is ergonomically adjustable and/or improves.

Further preferably, such adjustment means relate to continuous adjustment means, such as embodied by means of clamping means providing a clamping between the support member and the support element, or embodied by means of screw means providing a mutual displacement between a length of threaded wire and a screw member, such as a nut. With this, a relatively high precision of the adjustability is achieved. Alternatively, such adjustment means relate to discrete adjustment positions, such as by means of insertion or screwing of at least a pin or bolt in respective insertion positions determining the discrete adjustment positions. With this, a relatively easy choice of the adjustment positions is realized, such as for example based on adjustment rules.

According to a further preferred embodiment, the bicycle seat comprises bumper means against impacts or abrasion, such as for protecting of the buffer means, preferably embodied as an extending edge of the support element extending sideways beyond the dimension or a shape of the buffer means. With this, it is advantageously achieved to reduce wear off relatively soft buffer means by receiving such bumping or scraping against for example a wall by these buffer means. Such buffer means are for example embodied as parts of the support element that extend beyond the buffer means sideways or bumpers on the support elements.

A further aspect according to the present invention relates to a bicycle seat or kit, comprising the bicycle seat and the support assembly. Such aspect according to the present invention provides advantages as indicated in relation to the above aspects.

A further aspect according to the present invention relates to a kit comprising a bicycle seat and at least a handle, wherein the top surface of a seat surface of the bicycle seat and the gripping surface of the handle substantially have the same appearance and or tactile characteristics, preferably comprising a similar kind of material and/or the same material. Such aspect according to the present invention provides as advantage that comfort providing elements of the bicycle provide a corresponding appearance or impression to the user because of which a perception of a function correspondence thereof with respect to comfort is perceived by the rider to a high degree.

### BRIEF DESCRIPTION OF THE DRAWINGS

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

FIG. 1 relates to a number of views of preferred embodiments in exploded side view, top view and side view.

FIG. 2 relates to a contact you in side view of further preferred embodiments.

FIG. 3 relates to a side view as a cutout and an exploded view in perspective of a further preferred embodiment.

FIG. 4 relates to a cutout fuel other further preferred embodiment into states of use.

FIG. 5 relates to representations of a detail of a further preferred embodiment.

FIG. 6 Relates to a representation in cutout of a detail of a further preferred embodiment.

FIG. 7 relates to a schematic representation of further preferred embodiments.

FIG. 8 relates to a top view of a further preferred embodiment.

FIG. 9 relates to an exploded view in perspective of a further preferred embodiment.

FIG. 10 relates to a perspective view of a detail of a further preferred embodiment.

### DESCRIPTION OF THE INVENTION

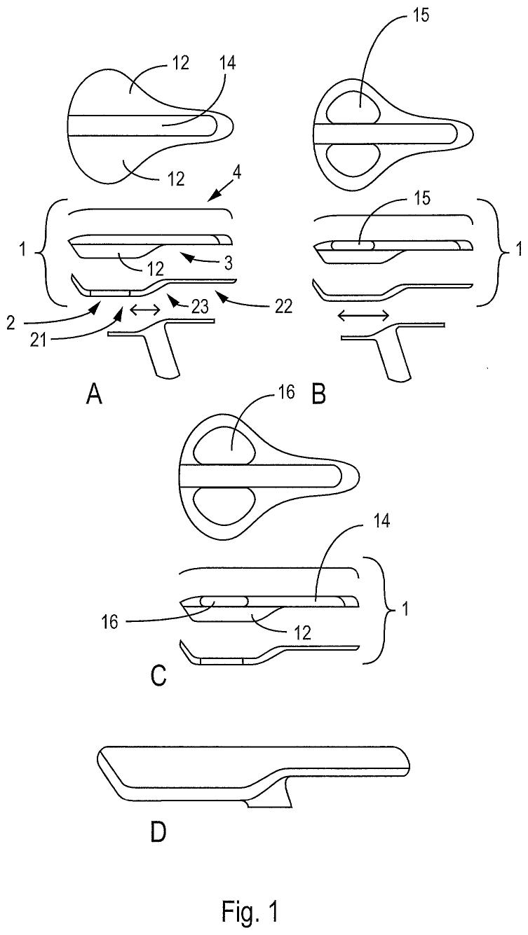

FIG. 1 shows a number of preferred embodiments according to the present invention. FIG. 1a shows a first preferred embodiments. In this preferred embodiment, the seat is formed by means of a support element 2, of which an important effect is that it provides support to the seat. Furthermore, the support element provides shape to the seat. On the support element, buffer means are arranged for improving forces between the bicycle and depression. During writing with the bicycle, the bicycle rolls over an unevenness that causes forces that are transferred to the rider via the seat. The purpose of the buffer means is to achieve dampening of such forces to the rider.

The top side of the buffer means determines the shape and the appearance of the top side of the seat. Furthermore, the cover layer provides protection for the buffer means, especially for relatively soft or damage prone parts thereof.

The seat is supported relative to the bicycle by a suspension member. The suspension member is preferably connectable with or connected to a saddle pin for arranging thereof relative to the bicycle. An advantage of such a support member according to preferred embodiments according to the invention is that the bicycle saddle is achievable without the use of a guide rail. With this, a significant amount of height is saved. The support element is arranged relative to the saddle pin, and there with relative to the gravity, under such an angle that an optimal angular orientation of the seat is achieved. A seat according to the present invention has as advantage that damaging or loosening of a saddle clamp cannot occur as the angle of the seat is always in order. An example substantially horizontal, less than 3° deviating from the horizontal, orientation fulfills UCI regulations.

The support element is conceived as a flat plate (see the following) or as a member with several zones of height. In case of for example a relatively low rear side relative to a relatively high front side allows for a relatively longer dampening travel or suspension travel at the rear side. It is an advantage that the combination of the support element with the buffer means saves height relative to a saddle according to the prior art because suspension under the seat base is avoided. With this, the support element is simpler, lighter or more advantageously producible than a seat base according to the prior art that needs to absorb all support forces. The transfer of forces from the rear side to the saddle pin is to a large degree simpler according to the present invention.

This support element is arranged for a horizontal displacement of 20 mm relative to the support member of the optional support assembly. In case of a forward arrangement, the sloping parts 23 of the support element 2 is arranged against a corresponding slope of the support member. In case of a rearward displacement relative to the forward arrangement, the sloping part 23 obtains distance, horizontal distance, relative to the corresponding sloping part of the support member.

This is the case with preferred embodiments according to FIG. 1. The embodiment according to A comprises a support element with a relatively low rear side in combination with a relatively high front side. With this, a relatively long suspension travel of these embodiments is achieved. For the purpose of this suspension travel, to distinct able zones of phone are provided, a relatively hard zone 12 directly on the support element with on top of that a relatively soft sound 14 for comfort of the rider. The relatively soft zone is limited to a strip or track in the middle of the seat that extent from the rear side to the front side. This zone provides a soft contact against the body at the location. The relatively hard zone extends at either side of the relatively soft zone from the support element are partly until the top side of the buffer means. This provides a firm suspension action or dampening action at the location of the respective left or right seat bone. The firm suspension action or dampening action of the heart from relative to the seat bone contributes to the relatively soft dampening of the middle track of soft from on the middle part of the body. With this, the seating assembly of the seat is covered by means of a cover layer.

The embodiment according to B alternatively has a similar hard foam layer that is directly arranged at the support element and to gas-filled, such as air filled dampening members 15. In comparison of a foam layer, These air filled dampening members provide a distinctable specific comfort with respect to dampening action and/or suspension action in relation to especially the body zone of the respective seat bone.

In a similar manner as the dampening members according to B, the preferred embodiment according to C provides dampening members 16 embodied as a specific phone directed at interaction with the seat bone. Alternatively, a filling with a gel is provided.

FIG. 1 D shows a side view of such preferred embodiments. In relation to the known bicycle seat, the present built, structure and features of preferred embodiments according to the present invention provide a distinct able appearance that improves the appearance as a whole of the bicycle in a surprising manner. The limited height over which a seat according to the present invention extends from the bottom side thereof to the top side thereof allows for usability of the bicycle for a larger range of leg lengths.

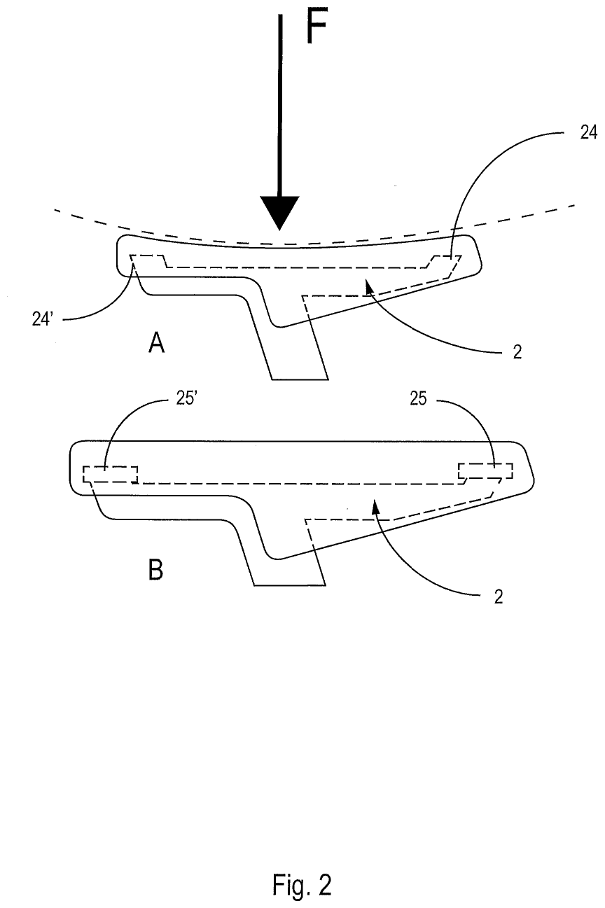

The preferred embodiments according to FIG. 2 are provided with a height increased part 24, 24′ of the support element at the front side and/or the rear side of the support element. With this, the support element provides an amount of suspension action at the respective side in itself by relatively high forces that are exerted by the body of the rider to the support element. With this, the support element also provides a certain amount of centering effect to the user with respect to the seat in the lengthwise direction thereof. In the variant according to FIG. 2 B, this increase in height 25, 25′ is embodied as a soft or resilient material, such as a rubber that softens forces that are exerted to the body because of the presence of this increased height.

The support member according to this preferred embodiment comprises a base plate 25 and a shape definition member 26, preferably arranged at the baseplate. This baseplate is arranged for a horizontal displacement relative to the support member of the optional support assembly. With this, the baseplate is provided with an elongated slot 31 for movably arranging therein of connecting means, such as a bolt for connecting of the support member 25 with a fixation plate 27, thereby exciting the baseplate. The slot 31 has an end 31′ at the front side thereof and an end 31″ at the rear side thereof.

The baseplate 25 according to this preferred embodiment provides substantially firmness and support to the bottom side of the saddle. The shape definition member 26 provides a connection between the baseplate and the buffer means that are arrangeable on top of the shape definition member 26. The shape definition means comprise a recess 29 for receiving of at least a part of the buffer means, for contributing to the length of a suspension travel or dampening travel thereof. Furthermore, the shape definition means comprise an opening 28 for arranging therein of the fixation plate 27 in any displaced state of the seat relative to the support member. When the seat is arranged in the frontmost state, the fixation plate is at the rear side of this opening 28 and when the seat is arranged in the rearmost state, the fixation plate is at the front side of this opening 28. Furthermore, this preferred embodiment comprises variants of foam fillings as described in the above.

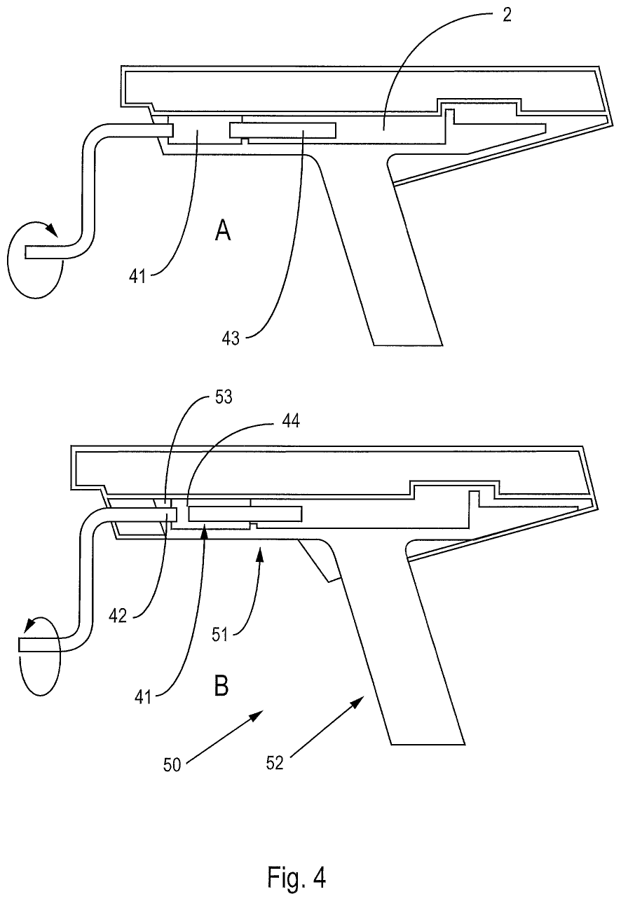

The preferred embodiment according to FIG. 4 relates to a variant wherein the seat is continuously adjustable by means of a horizontal screw connection relative to the support member 51 and saddle pin 52 of the support assembly 50. A nut 41, preferably with an elongated shape for providing of friction, with an in the thread is rotationally fastened to the support elements. A length of threaded wire 43 is fixedly fastened relative to the support element 2 of the seat. The end part 42 of the nut 41 is provided with grippers for an Allen key that can be accessed by an opening 53 in the support member. The rotational fastening of the note in the support member is achievable by means of a slot 44 in which, preferably on both sides, a ridge of the support element extends. As a result, horizontal adjustment of the seat in relation to the support member is achieved in this preferred embodiment.

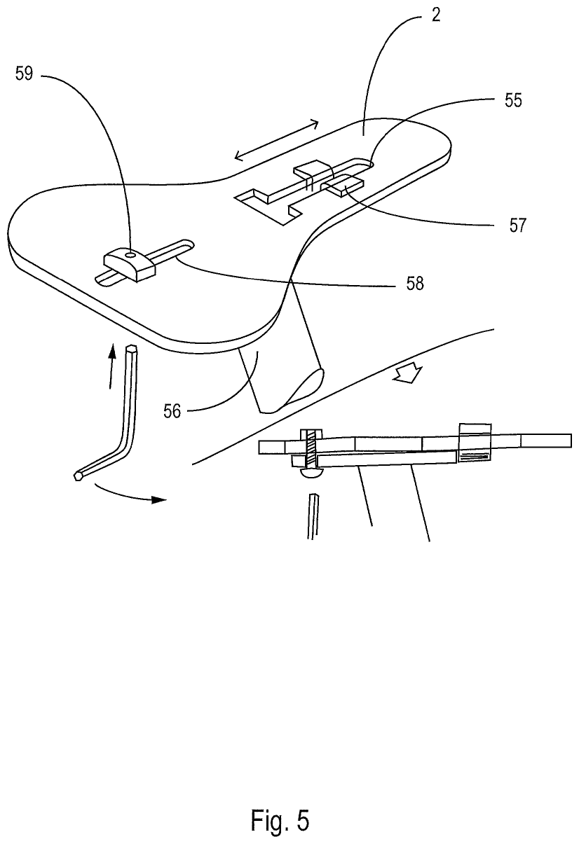

An alternative fastening with horizontal adjustability of the seat relative to the support member is shown in FIG. 5. Herein, the support member of the seat comprises a T-shaped slot 55, 56 wherein a slot part 55 facilitates a beyond the support member extending T-piece 57. At the rear side of the support member, a fixation slot 58 for fixation of the support member relative to the support element is arranged by means of a sliding bolt 59. Alternatively, the head of this sliding bolt is arrangeable and embedded in the support member. With this, the dampening action or the suspension action of the buffer member that is arranged above is unaffected. An advantage of such a preferred embodiment is that the displaceability and fixation may be performed by means of a single operation of the sliding bolt 59.

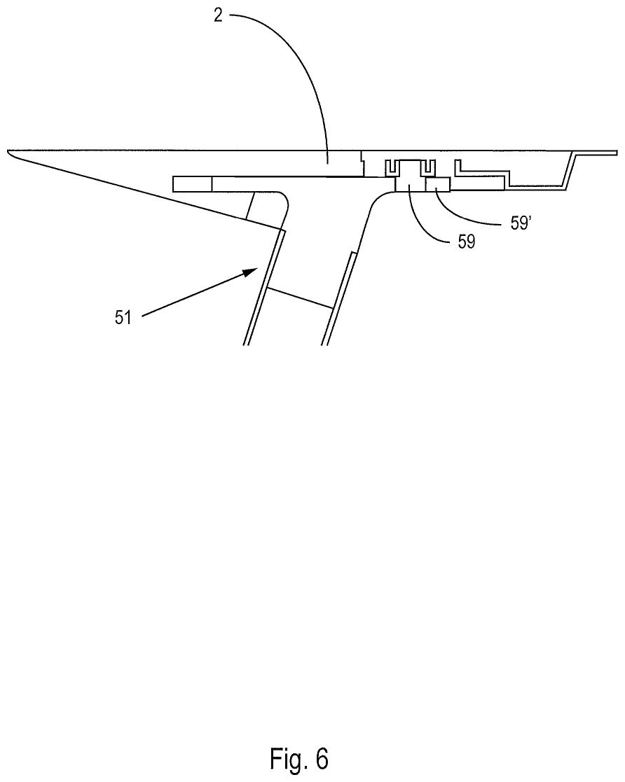

The preferred embodiment according to FIG. 6 provides a simple adjustment in 3 settings of the horizontal display stability of the seat. To this end, the support element 2 is provided with three embedded nuts 58, 58′, 58″. These embedded nuts server for screwing therein of the adjustment bolt 59 when an opening 59′ is arranged at the location of the embedded nuts. With this, the support element to according to this preferred embodiment is horizontally adjustable in three settings.

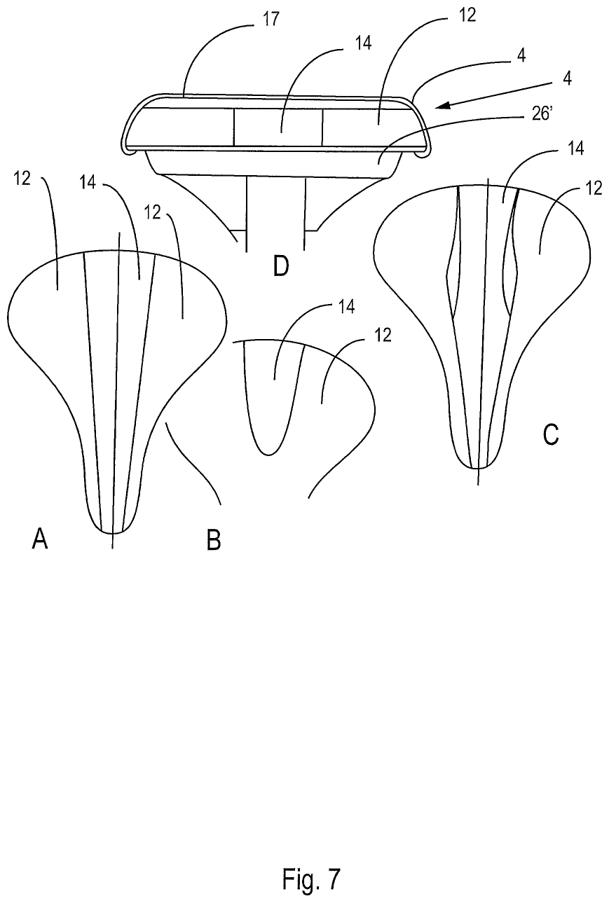

The already indicated distinct able zones of material are shown in greater detail in FIG. 7 in several preferred embodiments. These embodiments differ with respect to the shape of the zones of material. Variant A relates to a variant with a track of soft foam 14 arranged in a zone of material with heartfelt 12, wherein the track is wider at the rear side of the seat then at the front side and extends from the rear side to the front side. Variant B relates to a variant with a substantially elongated zone of material was soft foam 14 that is arranged at the rear side for providing of a soft dampening at that location. Variant C relates to a similar variant as variant A wherein the track of soft foam 14 that extends from the front side to the rear side has a widening at the location of the widening of the seat, or about one third from the rear of the seat. This variant provides a higher degree of soft dampening at that location.

Variant D provides, next to the zone of material of the hard foam 12 and the soft foam 14, a zone of material of memory foam 17 on top of that. This is further covered by a cover layer 4. The zone of material of memory foam 17 provides as optionally added comfort layer additional seat comfort for the writer of the bicycle.

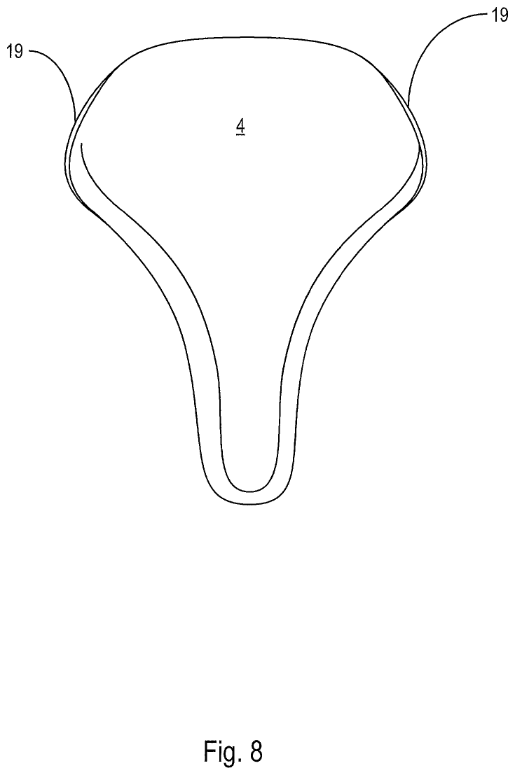

FIG. 8 shows a top view of a preferred embodiment of a further bicycle seat according to the present invention. Along the sides of the widest part of the bicycle seat, bumper means 19 are arranged, such as embodied as an extending part of the support element or as a bumper as along the support element for protection of the buffer means and/or the cover layer 4.

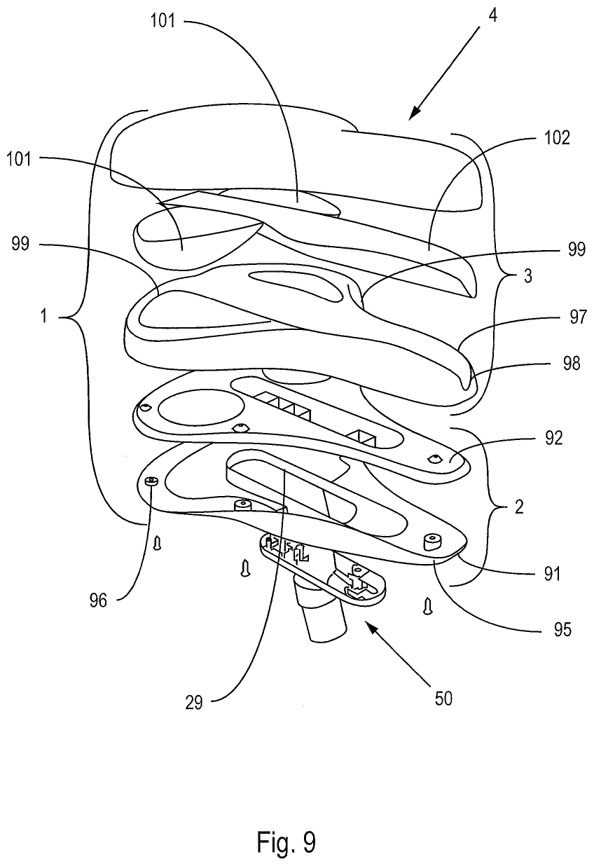

FIG. 9 shows an exploded view in perspective view of a further preferred embodiment. This comprises a support element made from a plastic wherein the firmness is obtained by the shape and by incorporated ribs. Furthermore, the support element 2 is manufactured from a top part 92 and a bottom part 91 that are mountable, such as by means of a screw connection 95 or a step connection. In the top part 92, spaces that are filled with buffer material 96 are provided for providing of a suspension action or a dampening action. On top of that, a layer of hard foam 97 is arranged with therein a central channel 98 and two openings 99 for arranging therein of a soft foam. Also the central channel 98 is filled with a foam, preferably memory foam. A reason for this is that with this, in combination with seat comfort, and even top services provided which is advantageous for prevention of water, such as rainwater, that remains in the channel, and because it provides a better appearance to the top surface 4 of the seat.

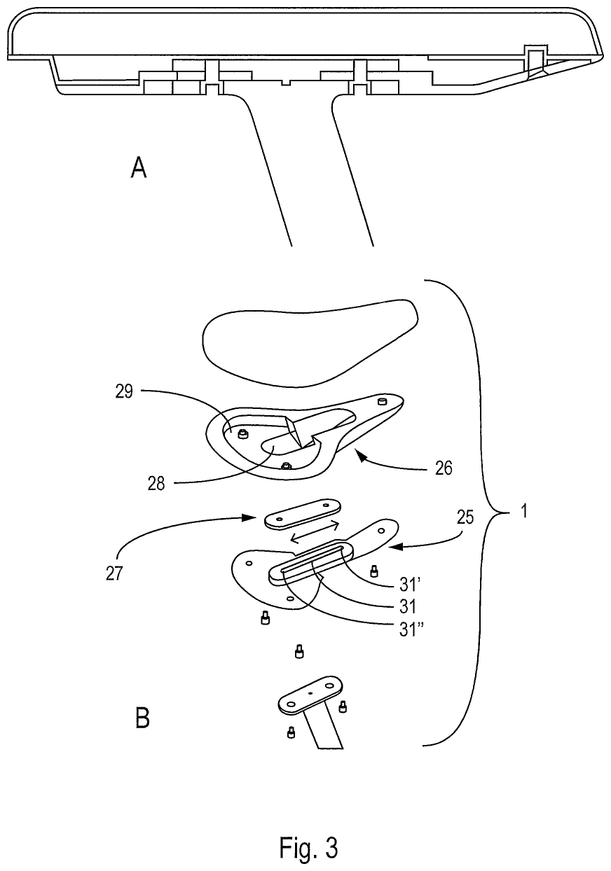

By the vertical coaction of the bodies 96, 97 and 101, within the understanding of the present invention, a comfortable suspension action is provided bulk to the buffer body with a sufficient suspension travel and/or dampening travel and a sufficient buffering. Also, the horizontal slide ability is provided wherein the support member is displaceable in the slot shaped opening 29, such as with the embodiment according to for example FIG. 3 is described in greater detail.

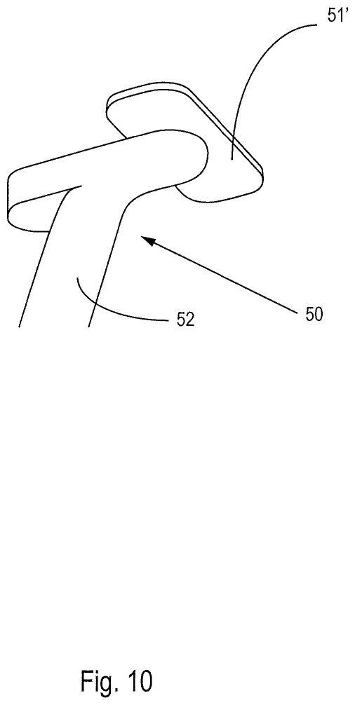

FIG. 10 provides a further variant of the optional support assembly 50 with a transverse support 51′ relative to the support element in the width thereof. The support assembly is achieved in various ways. A variant is that the support assembly is formed from a whole or is formed to a whole, with a saddle pin 52. A further variant is that a support member is provided for mounting to the top side of the saddle pin, preferably by means of a member befitting the saddle pin. With this, it is preferable that the support assembly to the underside of the support member fits within the profile of the saddle pin for maximum lower ability to the bottom side of the support member of the support assembly into the seat tube of the frame. With this, it is achieved that the top surface of the saddle extends as little as possible above the top side of the top tube of the frame. It is advantageously provided that a combination or a kit of a bicycle seat with a support assembly is provided.

According to preferred embodiment, the support element is substantially rigid. This means that the support element is substantially shape determining for providing of a shape in which support is provided in top view. Also, the support element determines the shape in side view. The support element is substantially rigid, which means that the support element is intended as a substantially fixed shape, but within the boundaries of material properties, it has elastic characteristics because of which it can deviate and therefore serve that are exerted on it by the human body or the writer of the bicycle.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. A bicycle seat for providing of a seat for a person on a bicycle, comprising:
an optional support assembly for mounting of the title to the bicycle, such as comprising a support member for supporting by the support assembly of a seat assembly wherein the support member is preferably mountable or fastened to a saddle pin,
the seat assembly comprising:
a support element,
fixation means for fixation of the seat assembly to the support member,
buffer means, supported by the support element, for providing of a buffering all forces between the bicycle and the person,
a seat surface defined by the upper side of the buffer means, wherein:
the support element provides a substantially rigid support supporting the buffer means relative to the support member,
the support element in top view substantially defines the shape of this support, and
the support element is arrangeable on the support member.

2. The bicycle seat according to claim 1, wherein the support element is embodied as a support body, preferably embodied as a formed body, further preferably formed by means of a molding operation or a forming operation from a plate material.

3. The bicycle seat according to claim 1, wherein the buffer means are arrangeable on or are arranged on the support element.

4. The bicycle seat according to claim 1, wherein the buffer means comprise at least one zone of material wherein each at least one zone of material comprises predetermined buffer characteristics in itself.

5. The bicycle seat according to claim 1, wherein the buffer means comprise at least one height zone wherein each at least one height zone comprises predetermined buffer characteristics in itself.

6. The bicycle seat according to claim 1, wherein the buffer means define a suspension travel depending on a force exerted thereon by a person.

7. The bicycle seat according to claim 1, are in the buffer means comprise at least a resilient support element, preferably two resilient support elements on both sides relative to the middle as seen in the direction of travel, preferably wherein the resilient support element comprises a gas-filled suspension element, preferably wherein the resilient support member comprises a gas-filled suspension element, optionally wherein the resilient support member comprises spring means, such as a sheet spring or a compression spring, such as a conical compression spring.

8-10. (canceled)

11. The bicycle seat according to claim 4, wherein the at least one zone of material comprises at least one zone of material with a hard foam and/or at least one zone of material with a soft foam.

12. The bicycle seat according to claim 4, wherein the at least one zone of material comprises a soft zone of material or a hard zone of material between the left side and the right side of the saddle.

13. (canceled)

14. The bicycle saddle according to claim 1, comprising a resilient support, such as comprising a rubber, at the front side and/or at the rear side of the saddle.

15. The bicycle saddle according to claim 1, wherein the bottom side of the buffer means are formed by a holder layer holding dampening material or the resilient support element.

16. The bicycle seat according to claim 1, wherein the buffer means comprise a comfort layer, such as comprising memory foam, soft PP and/or hard PP.

17. The bicycle seat according to claim 1, are in the seat surface is formed by the top side of the buffer means and/or by a cover layer or wear layer.

18. The bicycle seat according to claim 1, wherein the support element defines a height variation for providing of at least height zones, each with a respective vertical push in travel or suspension travel.

19. The bicycle seat according to claim 1, comprising adjustment means for adjusting of the position of the seat assembly relative to the support member in a horizontal direction, such as in the direction of travel of the bicycle, preferably wherein the adjustment means relate to continuous adjustment means, such as embodied by means of clamping means providing a clamping between the support member and the support element, or embodied by means of screw means providing a mutual displacement between a length of threaded wire and a screw member, such as a nut, and/or wherein the adjustment means define discrete adjustment positions, such as by means of insertion or screwing of at least a pin or bolt in respective insertion positions determining the discrete adjustment positions.

20. (canceled)

21. (canceled)

22. The bicycle seat according to claim 1, comprising bumper means against impacts or abrasion, such as for protecting of the buffer means, preferably embodied as an extending edge of the support element extending sideways beyond the dimension or a shape of the buffer means.

23. The bicycle seat according to claim 1, wherein the support element comprises a base plate and the shape definition member that is arranged or arrangeable thereto.

24. A bicycle seat or kit, comprising the bicycle seat and the support assembly.

25. A kit comprising a bicycle seat and at least a handle, wherein the top surface of a seat surface of the bicycle seat and the gripping surface of the handle substantially have the same appearance and or tactile characteristics, preferably comprising a similar kind of material and/or the same material.
